(19) United States
(12) Patent Application Publication
(10) Pub. No.: US 2012/0250291 A1
(43) Pub. Date: Oct. 4, 2012

(54) BACKLIGHT DEVICE AND DISPLAY APPARATUS

(76) Inventor: Takahisa Kaihotsu, Tokyo (JP)

(21) Appl. No.: 13/329,052

(22) Filed: Dec. 16, 2011

(30) Foreign Application Priority Data
Mar. 30, 2011 (JP) 2011-076136

(51) Int. Cl. G09F 13/04

(52) U.S. Cl. 362/97.1

(57) ABSTRACT

According to one embodiment, a display apparatus includes a display panel, a first light source, a second light source, and a first light guide plate. The first light source is configured to emit light to a first area on the display panel. The second light source is located inside a rim of the display panel, and facing a different direction from the first light source. The first light guide plate is configured to guide light emitted from the second light source toward a second area on the display panel. The second area is closer to the rim of the display panel than the first area.

### CROSS REFERENCE TO RELATED APPLICATIONS

This application is based upon and claims the benefit of priority from the prior Japanese Patent Application No. 2011-76136, filed on Mar. 30, 2011, the entire contents of which are incorporated herein by reference.

### FIELD

Embodiments described herein relate generally to a backlight device and a display apparatus.

### BACKGROUND

Recently, LCDs (liquid crystal displays) are widely used. A liquid crystal display has a liquid crystal panel composed by putting liquid crystal materials between a pair of glass substrates, and a backlight device for irradiating light on the liquid crystal panel from back side thereof. The backlight devices can be roughly classified into “edge type” and “direct-lighting type”.

With regard to the backlight device of edge type, light is irradiated from a light source such as an LED (Light emitting diode) to the side face of a light guide plate arranged behind the liquid crystal panel, and the widely-diffused light is taken out from a face of the light guide plate facing the liquid crystal panel. According to the edge type, the backlight device can be thin. However, there are some problems that it is difficult to irradiate the light on the center of the liquid crystal panel brightly in a case of LCDs having a large panel, which may cause brightness-unevenness, and that it is necessary to provide a wide bezel due to the light source. Because of the wide bezel, the display area may be appeared small.

On the other hand, with regard to the backlight device of the direct-lighting type, the light source is arranged directly below the liquid crystal panel, and the light is irradiated on the liquid crystal panel through the diffusion plate, and so on. According to the direct-lighting type, comparing to the edge type, the brightness unevenness can be suppressed because the center of the liquid crystal panel can be bright, and the bezel can be narrow. However, there are some problems that it is necessary to provide a thick backlight device and to provide a lot of light sources, which may cause an expensive cost.

### BRIEF DESCRIPTION OF THE DRAWINGS

FIG. 1 is a schematic block diagram of an image display system having an image display apparatus 110 according to one embodiment.

FIG. 2 is a schematic block diagram of the display module 200.

FIG. 3 is a perspective view of the backlight device 6 and the liquid crystal panel 1.

FIG. 4 is a front view of the backlight device 6 and the liquid crystal panel 1 of FIG. 3 seen from the direction A.

FIG. 5 is a front view of the backlight device which is a modified example of the backlight device 6.

FIG. 6 is a front view of the backlight device which is another modified example of the backlight device 6.

FIG. 7 is a front view of the backlight device which is another modified example of the backlight device 6.

FIG. 8 is a front view of the backlight device which is another modified example of the backlight device 6.

FIG. 9 is a front view of the backlight device of FIG. 8 seen from the direction A.

FIG. 10 is a perspective view of the backlight device 6a.

FIG. 11 is a perspective view of the backlight device 6b.

FIG. 12 is a perspective view of the backlight device 6c.

FIG. 13 is a perspective view of the backlight device 6f.

### DETAILED DESCRIPTION

In general, according to one embodiment, a display apparatus includes a display panel, a first light source, a second light source, and a first light guide plate. The first light source is configured to emit light to a first area on the display panel. The second light source is located inside a rim of the display panel, and facing a different direction from the first light source. The first light guide plate is configured to guide light emitted from the second light source toward a second area on the display panel. The second area is closer to the rim of the display panel than the first area.

Embodiments will now be explained with reference to the accompanying drawings.

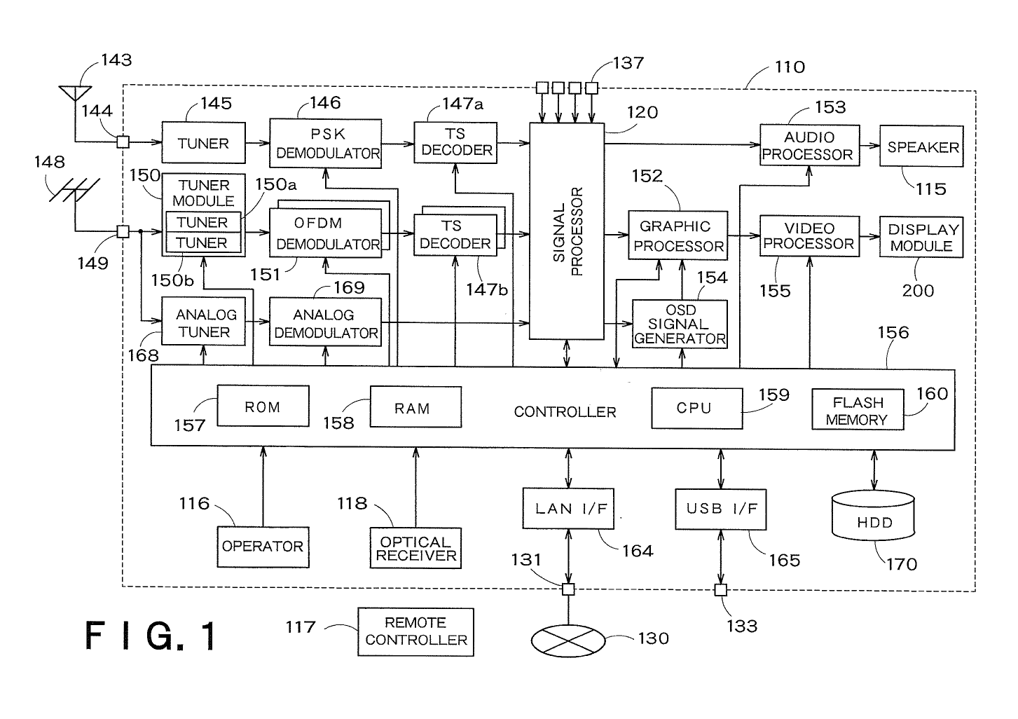

FIG. 1 is a schematic block diagram of an image display system having an image display apparatus 110 according to one embodiment.

The image display apparatus 110 has a controller 156 for controlling operations of each part, an operator 116, an optical receiver 118. The controller 156 has a ROM (Read Only Memory) 157, a RAM (Random Access Memory) 158, a CPU (Central Processing Unit) 159 and a flash memory 160.

The controller 156 activates a system control program and various processing programs stored in the ROM 157 in advance in accordance with an operation signal inputted from the operator 116 or inputted through the optical receiver 118 sent from the remote controller 117. The controller 156 controls the operations of each part according to the activated programs using the RAM 158 as a work memory of the CPU 159. Furthermore, the controller 156 stores and uses information and so on necessary for various settings in the flash memory 160 which is a non-volatile memory such as a NAND flash memory, for example.

The image display apparatus 110 further has an input terminal 144, a tuner 145, a PSK (Phase Shift Keying) demodulator 146, a TS (Transport Stream) decoder 147a and a signal processor 120.

The input terminal 144 sends a satellite digital television broadcasting signal received by an antenna 143 for receiving a BS/CS digital broadcast to the tuner 145 for the satellite digital broadcast. The tuner 145 tunes the received digital broadcasting signal to send the tuned digital broadcasting signal to the PSK demodulator 146. The PSK demodulator 146 demodulates the TS from the digital broadcasting signal to send the demodulated TS to the TS decoder 147a. The TS decoder 147a decodes the TS to a digital signal including a digital video signal, a digital audio signal and a data signal to send it to the signal processor 120.

Here, the digital video signal is a digital signal relating to a video which the image display apparatus 110 can output. The digital audio signal is a digital signal relating to an audio which the image display apparatus 110 can output. Furthermore, the data signal is a digital signal indicative of various kind of information about demodulated serves.

The image display apparatus 110 further has an input terminal 149, a tuner module having two tuners 150a and 150b, two OFDM (Orthogonal Frequency Division Multiplexing) demodulators 151, two TS decoders 147b, an analog tuner 168 and an analog demodulator 169.

The input terminal 149 sends a terrestrial digital television broadcasting signal received by an antenna 148 for receiving the terrestrial digital broadcast to the tuner 150 for the terrestrial digital broadcast. The tuners 150a and 150b in the tuner module 150 tune the received digital broadcasting signal to send the tuned digital broadcasting signal to the two OFDM demodulators 151, respectively. The OFDM demodulators 151 demodulate the TS from the digital broadcasting signal to send the demodulated TS to the corresponding TS decoder 147b. The TS decoder 147b decodes the TS to a digital video signal and a digital audio signal and so on to send them to the signal processor 120. The terrestrial digital television broadcast obtained by each of the tuners 150a and 150b in the tuner module 150 are decoded to the digital video signal, the digital audio signal and the digital signal including the data signal simultaneously by the two OFDM demodulators 151 and the TS decoders 147b, and then, can be sent to the signal processor 120.

The antenna 148 can also receive a terrestrial analog television broadcasting signal. The received terrestrial analog television broadcasting signal is divided by a divider (not shown) and sent to the analog tuner 168. The analog tuner 168 tunes the received analog broadcasting signal and sends the tuned analog broadcasting signal to the analog demodulator 169. The analog demodulator 169 demodulates the analog broadcasting signal to send the demodulated analog broadcasting signal to the signal processor 120. Furthermore, the image display apparatus 110 can display CATV (Common Antenna Television) by connecting a tuner for the CATV to the input terminal 149 connected to the antenna 148, for example.

The image display apparatus 110 further has a line input terminal 137, an audio processor 153, a speaker 115, a graphic processor 152, an OSD (On Screen Display) signal generator 154, a video processor 155 and a display 220.

The signal processor 120 performs a suitable signal processing on the digital signal sent from the TS decoders 147a and 147b or from the controller 156. More specifically, the signal processor 120 divides the digital signal into the digital video signal, the digital audio signal and the data signal. The digital video signal is sent to the graphic processor 152, and the divided digital audio signal is sent to the audio processor 153. Furthermore, the signal processor 120 converts the broadcasting signal sent from the analog demodulator 169 to a video signal and an audio signal in a predetermined digital format. The converted digital video signal is sent to the graphic processor 152, and the converted digital audio signal is sent to the audio processor 153. Furthermore, the signal processor 120 performs a digital signal processing on an input signal from the line input terminal 137.

The audio processor 153 converts the inputted audio signal to an analog audio signal in a format capable of being reproduced by the speaker 115. The analog audio signal is sent to the speaker 115 and is reproduced.

The OSD signal generator 154 generates an OSD signal for displaying an UI (User Interface) window or the like in accordance with a control of the controller 156. Furthermore, the data signal divided by the signal processor 120 from the digital broadcasting signal is converted to the OSD signal in a suitable format and is sent to the graphic processor 152.

The graphic processor 152 decodes the digital video signal sent from the signal processor 120. The decoded video signal is combined with the OSD signal sent from the OSD signal generator 154 and is sent to the video processor 155. The graphic processor 152 can send the decoded video signal or the OSD signal selectively to the video processor 155.

The video processor 155 converts the signal sent from the graphic processor 152 to an analog video signal in a format the display module 200 can display. The analog video signal is sent to the display module 200 to be displayed. The display module 200 is, for example, a crystal liquid display having a size of “12” inch or “20” inch.

The image display apparatus 110 further has a LAN (Local Area Network) terminal 131, a LAN I/F (Interface) 164, a USB (Universal Serial Bus) terminal 133, a USB I/F 165 and a HDD (Hard Disk Drive) 170.

The LAN terminal 131 is connected to the controller 156 through the LAN I/F 164. The LAN terminal 131 is used as a general LAN-corresponding port using an Ethernet (registered trademark). In the present embodiment, a LAN cable is connected to the LAN terminal 131, and it is possible to communicate with an internet 130.

The USB terminal 133 is connected to the controller 156 through the USB I/F 165. The USB terminal 133 is used as a general USB-corresponding port. For example, a cellular phone, a digital camera, a card reader/writer for various memory cards, a HDD and a key board or the like can be connected to the USB terminal 133 through a hub. The controller 156 can communicate with devices connected through the USB terminal 133.

The HDD 170 is a magnetic storage medium in the image display apparatus 110, and has a function for storing various information of the image display apparatus 110.

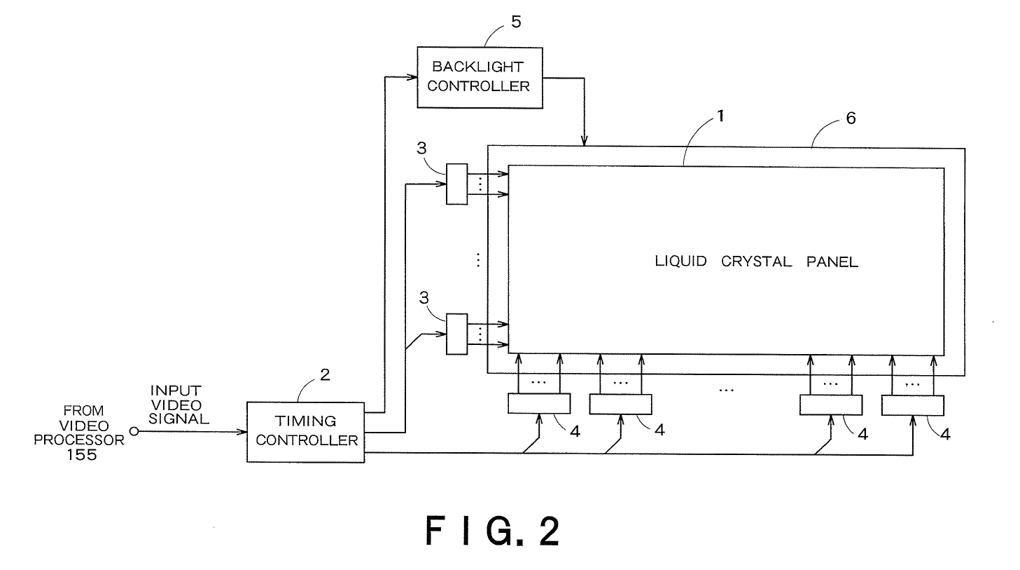

FIG. 2 is a schematic block diagram of the display module 200. The display module 200 has a liquid crystal panel (display panel) 1, a timing controller 2, a gate driver 3, a source driver 4, a backlight controller 5, and a backlight module 6.

The liquid crystal panel 1 has a structure where liquid crystal materials are put between a pair of facing glass substrates. The liquid crystal panel 1 has a plurality of (for example, “1080” of) scanning lines, a plurality of (for example, “1920*3” of) signal lines, and a plurality of liquid crystal pixels formed on each of crossing points of the scanning lines and the signal line.

The timing controller 2 provides the input video signal inputted from the video processor 155 of FIG. 1 to the source driver 4 and controls the operation timing of the gate driver 3, source driver 4 and backlight controller 5.

The gate driver 3 selects one of the scanning lines by turns. The source driver 4 provides the input video signal to the signal lines of the liquid crystal panel 1. The input video signal is provided to the liquid crystal pixel connected to the scanning line selected by the gate driver 3. According to the voltage of the supplied input video signal, alignments of the liquid crystal materials in the liquid crystal pixel vary. The gate driver 3 and the source driver 4 form a panel controller.

On the other hand, the backlight module 6 is arranged behind the liquid crystal panel 1 to irradiate light thereon. Among the irradiated light, light whose intensity depends on the alignments of the liquid crystal materials, is transmissive to the liquid crystal materials to be displayed on the liquid crystal panel 1.

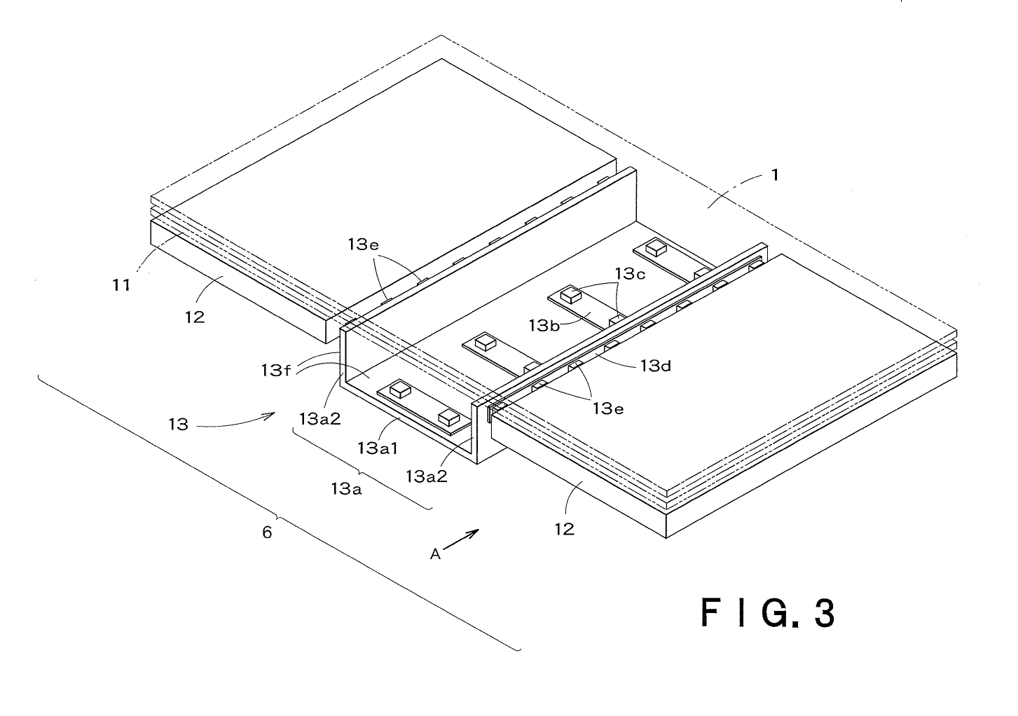

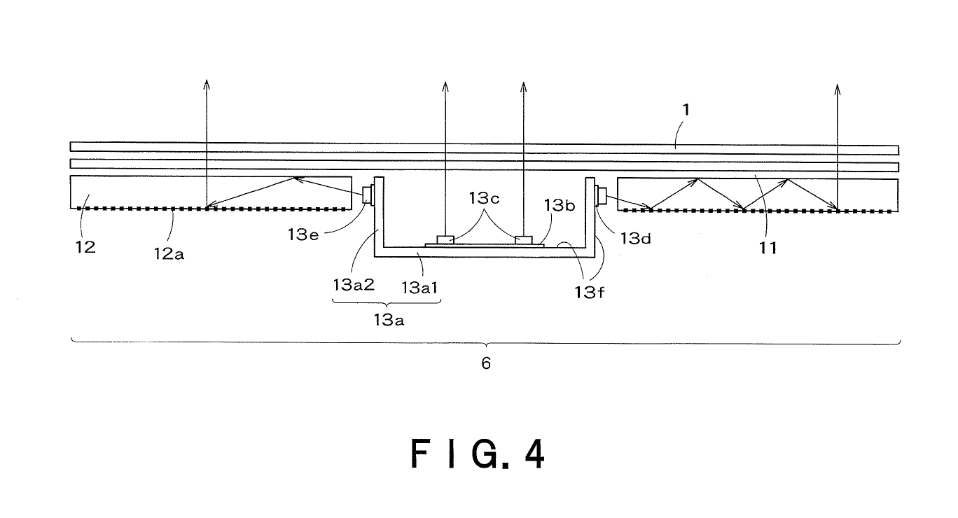

FIG. 3 is a perspective view of the backlight device 6 and the liquid crystal panel 1. FIG. 4 is a front view of the backlight device 6 and the liquid crystal panel 1 of FIG. 3 seen from the direction A. Hereinafter, the direction from the backlight device 6 toward the liquid crystal panel 1 will be referred to as the upward direction.

The backlight device 6 includes a diffuser plate (a diffuser member) 11, two light guide plates 12, and a light source module 13.

The diffuser plate is an acrylic or polyethylene terephthalate plate of approximately 1 mm in thickness, for example. The diffuser plate 11 is almost of the same size as the liquid crystal panel 1. The diffuser plate 11 is positioned to face the liquid panel 1, and is placed below the liquid panel 1. Instead of the diffuser plate 11, a diffuser sheet (film) may be used as the diffuser member. The diffuser plate 11 may be omitted.

The light guide plates 12 are rectangular plates that are made of acrylic and are approximately 2 mm in thickness, for example. The light guide plates 12 are arranged to face areas closer to the rim of the liquid crystal panel 1 than the light source module 13 is. For example, the light guide plates 12 are arranged to face left-side and right-side areas (second areas) of the diffuser plate 11. The light guide plates 12 are placed below the diffuser plate 11, so as to sandwich the light source module 13. A diffuser member 12a is applied by serigraph or the like to at least a part of the lower surfaces of the light guide plates 12, so that light is emitted toward the liquid crystal panel 1 located above the light guide plates 12. Furthermore, in order to restrain light diffusion and improve the linearity of traveling light, prism-like portions (not shown) along the traveling direction of light may be formed on the upper surfaces of the light guide plates 12. The prism-like portions have an apex angle of 90 degrees and a pitch of 10 μm.

A spacer (not shown) for maintaining a constant clearance may be inserted between each light guide plate 12 and the light source module 13, to stabilize the light guide plates 12. The material of the spacer is preferably an elastic material, with thermal expansion of the light guide plates 12 being taken into account. Further, an optical sheet (not shown) may be inserted between each light guide plate 12 and the diffuser plate 11, to improve the light usage efficiency.

The light source module 13 faces the central area (the first area) located on the inner side of the rims of the diffuser plate 11 and the liquid crystal panel 1, and is placed below the central area. The light source module 13 includes a substrate 13a, first LED light sources 13a attached to LED substrates 13b, and second LED light sources 13e attached to LED substrates 13d.

The substrate 13a includes a back face 13a1 (the first face) and two side faces (the second face) 13a2. The two side faces 13a2 are joined to the back face 13a1 at both ends, or are integrally formed with the back face 13a1. The back face 13a1 faces the diffuser plate 11, and the upper portions of the side faces 13a2 face the side faces of the respective light guide plates 12. The substrate 13a is formed by bending a metal or plastic plate of approximately 1 mm in thickness into a C-shape, for example. In FIG. 4, the height of each side face 13a2 is a few times greater than the height of each light guide plate 12. However, the actual height of each side face 13a2 is approximately 20 mm.

The first LED light sources 13c are attached to the LED substrates 13b, and the LED substrates 13b are attached to the back face 13a1 with double-sided adhesive tape, for example. The first LED light sources 13c emit light toward the diffuser plate 11. As described above, the back face 13a1 faces the center of the liquid crystal panel 1. In this central area, the light from the first LED light sources 13c reaches the liquid crystal panel 1, without passing through the light guide plates 12. Therefore, the center portion of the liquid crystal panel 1, which tends to draw attention of viewers, can be made particularly bright. Furthermore, a large number of first LED light sources 13c may be formed on the back face 13a1. Accordingly, the display area can be divided into several areas in the center of the liquid crystal panel 1, and so-called local dimming can be performed in each small area to control the luminance in the respective areas.

Although eight first LED light sources 13c are shown in the example illustrated in FIG. 3, the number of first LED light sources 13c may be changed as needed. For example, as the height of each side face 13a2 is lower, the distance from each first LED light source 13c to the diffuser plate 11 becomes shorter, and light diffusion is also smaller. Therefore, the number of first LED light sources 13c should be increased to restrain brightness-unevenness in the liquid crystal panel 1. Furthermore, to increase the amount of light to reach the liquid crystal panel 1, a reflective material 13f is preferably applied to the surface of the back face 13a1 to which the first LED light sources 13c are attached.

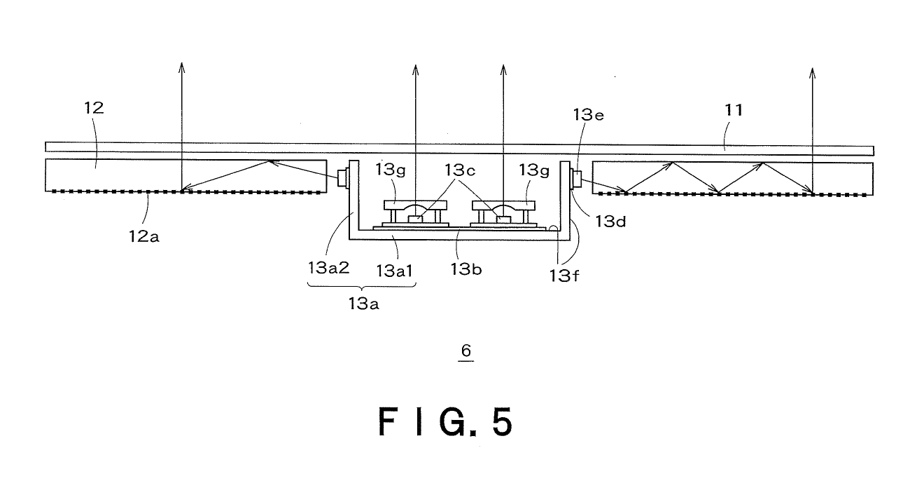

As shown in FIG. 5, diffusion lenses 13g may also be provided to cover the respective first LED light sources 13c. With this arrangement, the light emitted from the first LED light sources 13c diffuses, and thus, brightness-unevenness can be prevented in the liquid crystal panel 1 even if the number of first LED light sources 13c is small. It should be noted that, in FIG. 5 and the later drawings, the liquid crystal panel 1 is omitted.

Meanwhile, the second LED light sources 13e are attached to the LED substrates 13d, and the LED substrates 13d are attached to the portions of the two side faces 13a2 facing the respective light guide plates 12 with double-sided adhesive tape, for example. Therefore, unlike the first LED light sources 13c, the second LED light sources 13e are arranged to face the outside of the liquid crystal panel 1. The second LED light sources 13e emit light toward the side faces of the respective light guide plates 12. The light is guided through the inside of the light guide plates 12. At the locations without the diffuser member 12a in the light guide plates 12, the light is almost totally reflected. However, the light is extracted upward from the locations having the diffuser member 12a applied thereto. As a result, the light reaches the areas (the left-side and right-side areas) surrounding the central area of the liquid crystal panel 1 to which light is emitted from the first LED light sources 13c.

Since the linearity of light is improved by the prism-like portions on the upper faces of the light guide plates 12, one-dimensional (row-direction) local dimming can also be performed on the left-side and right-side areas of the liquid crystal panel 1 to which light is emitted from the second LED light sources 13e via the light guide plates 12.

At locations further away from the second LED light sources 13e, the amount of light traveling in the light guide plates 12 is smaller. Therefore, the diffuser member 12a is preferably applied to locations near the second LED light sources 13e at lower densities, and is preferably applied to locations further away from the second LED light sources 13e at higher densities, so that the liquid crystal panel 1 is prevented from having brightness-unevenness. Similarly, in order to increase the amount of light to reach the liquid crystal panel 1, the reflective material 13f is preferably applied to the surfaces of the side faces 13a2 having the second LED light sources 13e attached thereto.

Since the second LED light sources 13e are not placed outside the liquid crystal panel 1 but are placed below the liquid crystal panel 1, the bezel width can be made smaller. As a result, the display area can be made to appear larger, and it is possible to display by arranging a plurality of liquid crystal panels 1. Since the light emitted from the second LED light sources 13e reach both ends of the liquid crystal panel 1 via the light guide plates 12, the number of necessary LEDs can be made smaller. Further, the thickness of either side area of the liquid crystal panel 1 where the light source module 13 is not placed can be made particularly small.

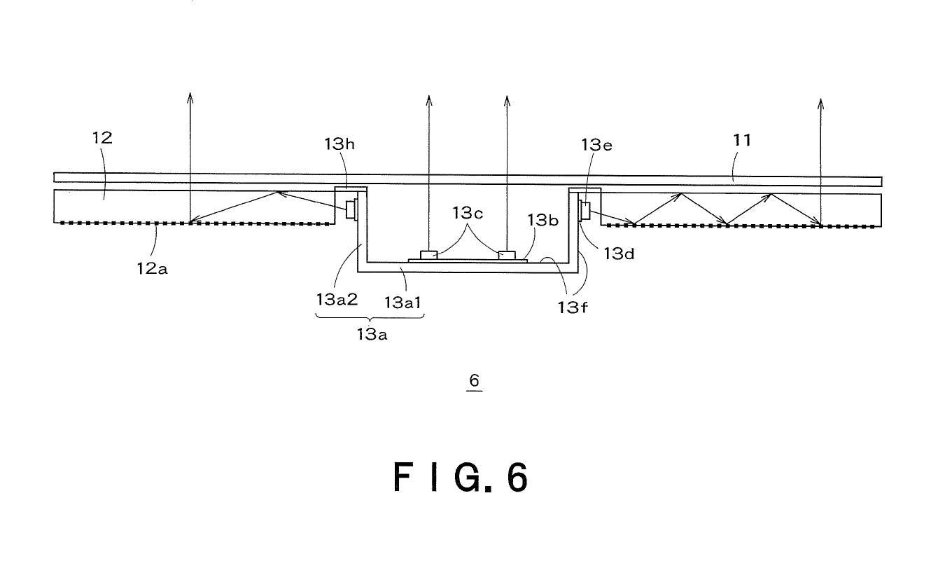

If the light emitted from the second LED light sources 13e does not enter the light guide plates 12 but diffuses and directly reaches the diffuser plate 11, brightness-unevenness might appear on the liquid crystal panel 1. Therefore, a light shielding plate 13h, for example, may be provided as a diffusion restraining member between each second LED light source 13e and the diffuser plate 11, as shown in FIG. 6. The surface of each light shielding plate 13h on the side of the second LED light sources 13e preferably has mirror-surface characteristics. This is because, when a part of the light emitted from the second LED light source 13e toward the light shielding plates 13h is reflected and enters the light guide plates 12, the light usage efficiency can be improved. If the light transmission factor of the light shielding plates 13h is too low, the portions of the liquid crystal panel 1 located directly above the second LED light sources 13e may become dark, causing brightness-unevenness. Therefore, the shielding plates 13h may be half mirrors having the function to transmit light and the function to reflect light.

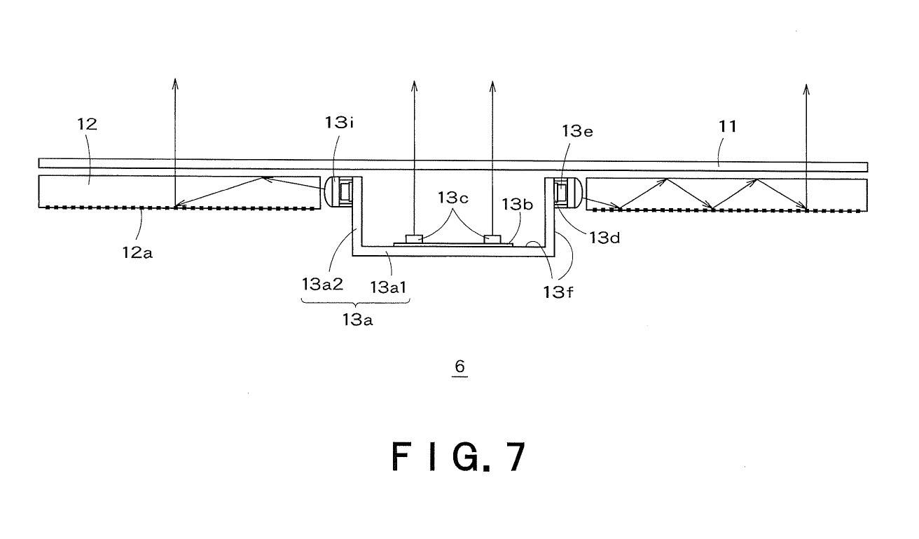

Alternatively, collimator lenses 13i may be provided as diffusion restraining members to cover the respective second LED light sources 13e, as shown in FIG. 7. With this arrangement, the light emitted from the second LED light sources 13e is guided in a direction substantially parallel to the light guide plates 12, and thus, light diffusing toward the diffuser plate 11 can be restrained.

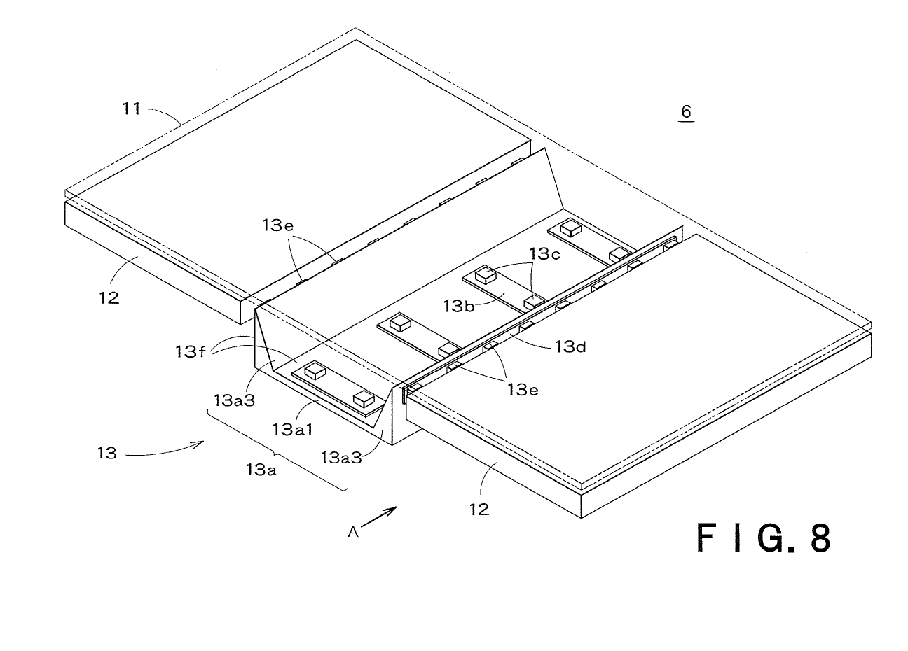

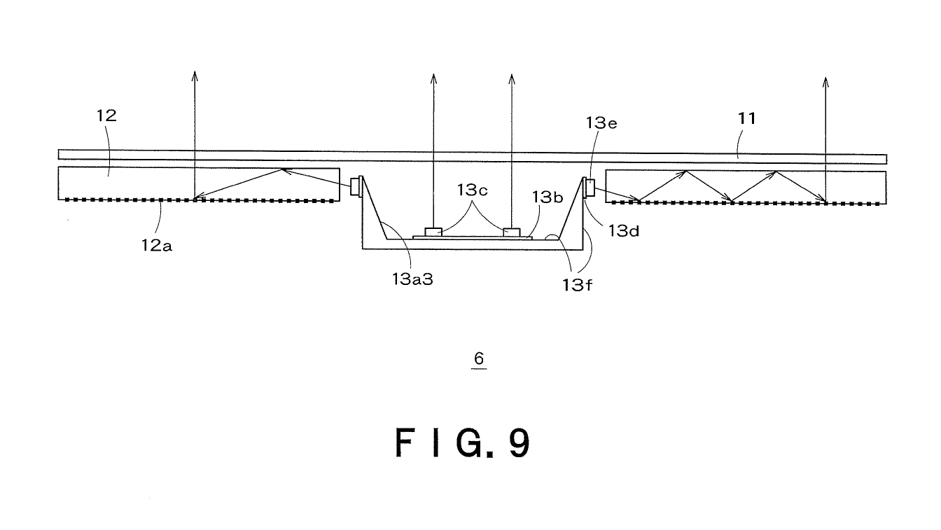

Further, as shown in FIGS. 8 and 9, sloping faces (the third face) 13a3 that slope from the diffuser plate 11 side toward the back face 13a1 side may be provided on the inner side of the substrate 13a. With this arrangement, striped brightness-unevenness in the portions of the liquid crystal panel 1 located above the side faces 13a2 can be restrained.

As described above, in this embodiment, the first LED light sources 13c are provided to face the center of the liquid crystal panel 1, and emit light that does not pass through the light guide plates 12. Accordingly, the light extraction efficiency is high, and the central area of the liquid crystal panel 1 can be made brighter. Furthermore, local dimming can be performed in each small area. It should be understood that one-dimensional (row-direction) local dimming can also be performed in the left-side and right-side areas of the liquid crystal panel 1 to which light is emitted from the second LED light sources 13e via the light guide plates 12.

Additionally, the two light guide plates 12 are placed to sandwich the light emitted from the first LED light sources 13c, and the second LED light sources 13e are placed not outside the liquid crystal panel 1 but between the light guide plates 12. Accordingly, a small bezel width can be achieved. As a result, the display area appears larger, and two or more liquid crystal panels 1 can be connected in a seamless manner. Furthermore, in the display module 200, the portions where the light source module 13 is not arranged can be made particularly thinner.

Some modifications of the above described backlight device 6 will be described as follows.

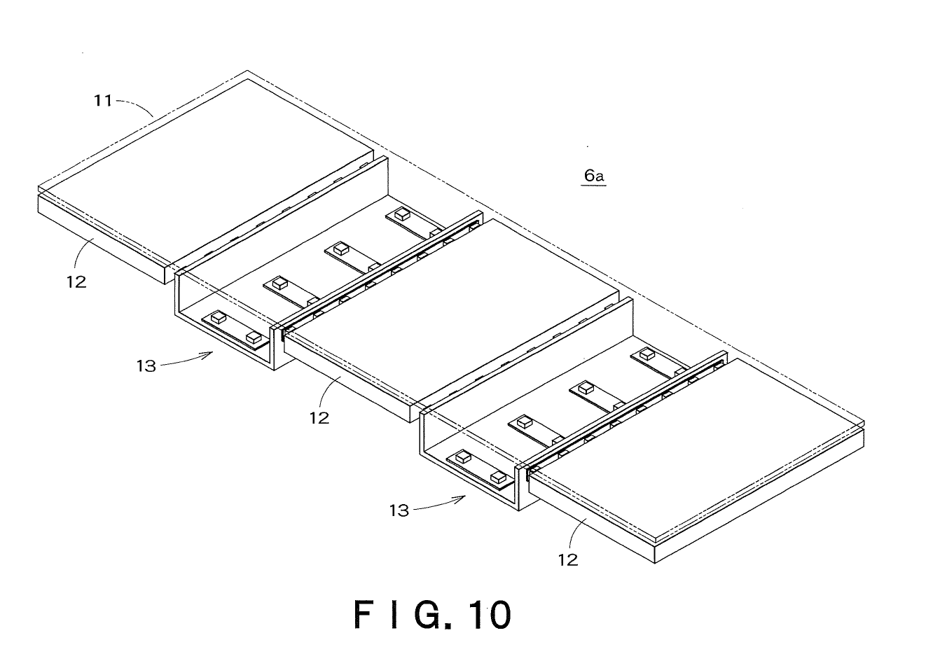

FIG. 10 is a perspective view of a first modification of the backlight device 6. The backlight device 6a shown in the drawing includes three light guide plates 12 and two light source modules 13. The light guide plates 12 are placed at the left-side and right-side ends, and at the center. The light source modules 13 are placed between the light guide plates 12. With this arrangement, local dimming can also be performed in areas to which light is emitted via the light guide plates 12. Although the first LED light sources 13c are not arranged at the center of the liquid crystal panel 1, light is emitted from the left-side and right-side second LED light sources 13e to the center of the liquid crystal panel 1. Accordingly, the center of the liquid crystal panel 1 can still be made particularly bright.

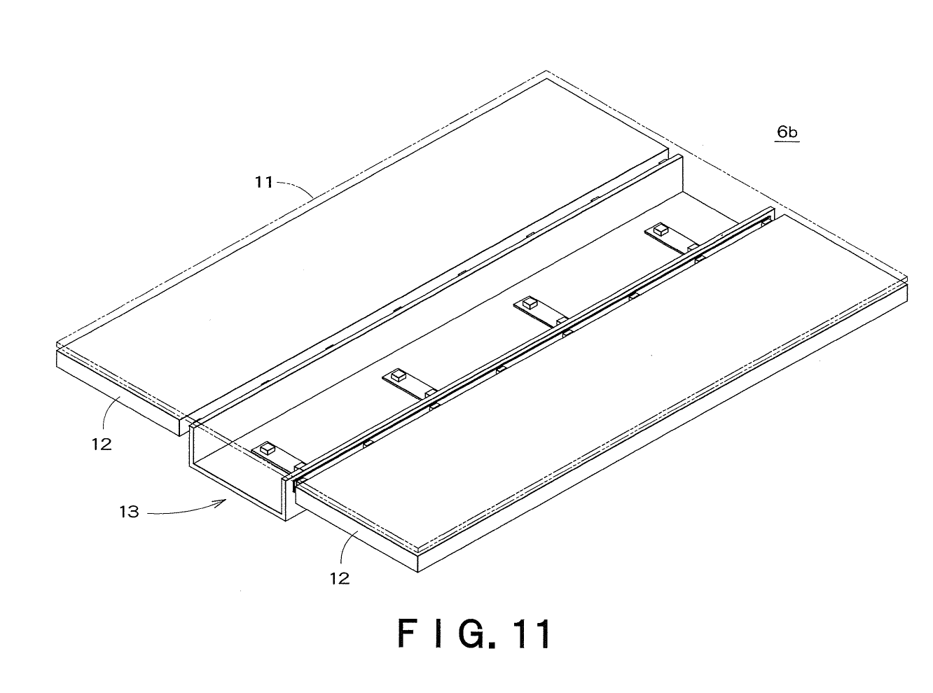

FIG. 11 is a perspective view of a second modification of the backlight device 6. As in the backlight device 6b shown in the drawing, the light guide plates 12 may be placed not in the left-side and right-side areas of the liquid crystal panel 1, but may be placed in the upper and lower areas of the liquid crystal panel 1. However, in a case where backlight scanning is performed on each scanning line to control the luminance to improve the video image resolution, it is preferable to use the structure illustrated in FIG. 3.

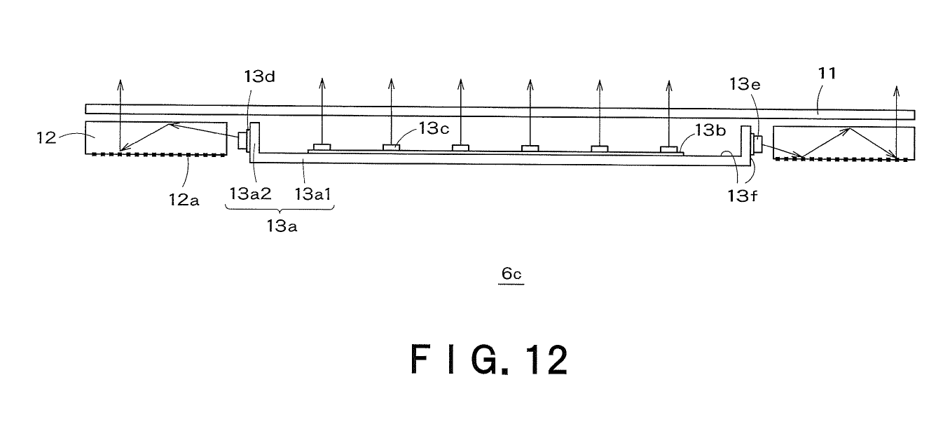

FIG. 12 is a cross-sectional view of a third modification of the backlight device 6. In the backlight device 6 illustrated in FIGS. 3 and 4, each light guide plate 12 is placed in approximately one-third of the entire area on either left or right side. However, as shown in the backlight device 6c in FIG. 12, the areas where the light guide plates 12 are placed may be made narrower, and the light source module 13 may be made wider. With this arrangement, the area to be brightly lit can be made larger. Alternatively, the areas where the light guide plates 12 are placed may be made smaller than those shown in FIGS. 3 and 4.

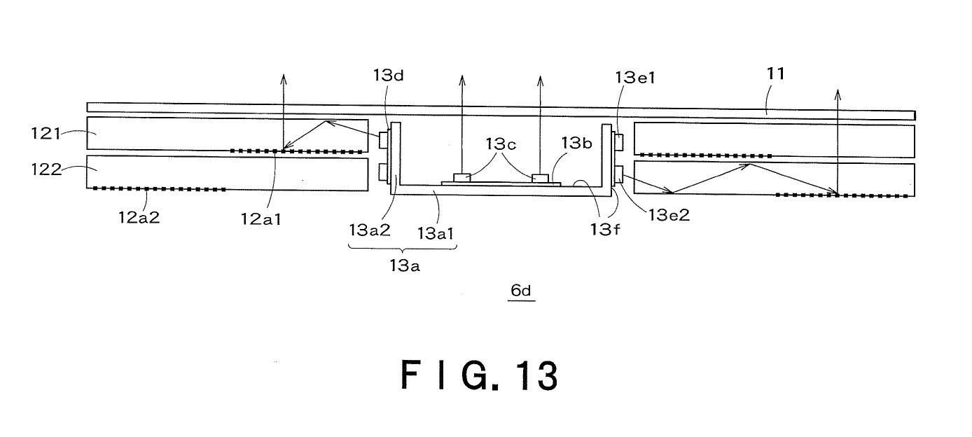

FIG. 13 is a cross-sectional view of a fourth modification of the backlight device 6. Unlike the backlight device 6 illustrated in FIG. 4, the backlight device 6d has first light guide plates 121 and second light guide plates 122 placed on the left and right sides of the light source module 13.

The first guide plates 121 face the diffuser plate 11, and are placed under the diffuser plate 11. The second guide plates 122 are placed under the first light guide plates 121. A diffuser member 12a1 is applied to the inner area (on the side of the light source module 13) of the lower surface of each of the first light guide plates 121, and a diffuser member 12a2 is applied to the outer area of the lower surface of each of the second light guide plates 122.

Further, second LED light sources 13e1 that emit light to the first light guide plates 121, and third LED light sources 13e2 that emit light to the second light guide plates 122 are attached to the side faces 13a2 of the substrate 13a. The second LED light sources 13e1 and the third LED light sources 13e2 are provided to face the outside of the liquid crystal panel 1. The light emitted from each second LED light source 13e1 travels from the face of the corresponding first light guide plate 121 having the diffuser member 12a1 applied thereto, toward the liquid crystal panel 1. The light emitted from each third LED light source 13e2 travels from the face of the corresponding second light guide plate 122 having the diffuser member 12a2 applied thereto, toward the liquid crystal panel 1.

Accordingly, the second LED light sources 13e1 emit light to the portions of the liquid crystal panel 1 located above the diffuser member 12a1, and the third LED light sources 13e2 emit light to the portions located above the diffuser member 12a2. As a result, by virtue of the backlight device 6d illustrated in FIG. 13, local dimming can be performed in even smaller areas located above the first and second light guide plates.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A display apparatus comprising:
a display panel;
a first light source configured to emit light to a first area on the display panel;
a second light source located inside a rim of the display panel, and facing a different direction from the first light source; and
a first light guide plate configured to guide light emitted from the second light source toward a second area on the display panel, the second area being closer to the rim of the display panel than the first area.

2. The apparatus of claim 1, wherein the first area includes at least a location corresponding to a central area of the display panel.

3. The apparatus of claim 1, further comprising a substrate facing the first area of the display panel, comprising:
a first face facing the first area; and
a second face, at least a part of the second face facing the first light guide plate,
wherein
the first light source is attached to the first face, and
the second light source is attached to a portion of the second face, the portion facing the first light guide plate.

4. The apparatus of claim 3, wherein a reflective material is applied to the first face and the second face.

5. The apparatus of claim 3, wherein the substrate comprises a third face sloping from the display panel side of the first face toward the second face side.

6. The apparatus of claim 1, further comprising a diffusion lens covering the first light source, and configured to diffuse the light emitted from the first light source.

7. The apparatus of claim 1, further comprising a diffusion restraining member configured to restrain an amount of light, the light being emitted from the second light source and diffusing into the display panel without passing through the first light guide plate.

8. The apparatus of claim 7, wherein the diffusion restraining member is a light shielding member between the second light source and the display panel.

9. The apparatus of claim 7, wherein the diffusion restraining member is a collimator lens covering the second light source, and configured to guide light emitted from the second light source in a direction parallel to the display panel.

10. The apparatus of claim 1, further comprising:
a third light source facing an identical direction as the second light source; and
a second light guide plate facing the first light guide plate, and configured to guide light emitted from the third light source toward a third area on the display panel, the third area being different from the first and second areas.

11. The apparatus of claim 1 further comprising a diffusion member between the display panel and the first light guide plate, and configured to diffuse light emitted from the first light source.

12. The apparatus of claim 1, further comprising a tuner configured to receive and tune a broadcasting signal,
wherein the display panel is configured to display the tuned broadcasting signal.

13. A backlight device comprising:
a first light source configured to emit light to a first area;
at least two light guide plates sandwiching the light emitted from the first light source, and configured to guide the emitted light toward a second area, the second area being at least a part of a surrounding area of the first area;
at least two light sources corresponding to the two light guide plates, between the two light guide source, facing a different direction from the first light source, and configured to emit light toward each of the light guide plates.

14. The device of claim 13 further comprising a diffusion member facing the first light source and the light guide plates.

15. The device of claim 14, wherein the first area includes at least a location corresponding to a central area of the diffusion member.

16. The device of claim 13, further comprising a substrate comprising:
a first face facing the first area; and
a second face, at least a part of the second face facing one of the light guide plates,
wherein
the first light source is attached to the first face, and
the second light source is attached to a portion of the second face, the portion facing the one of the light guide plates.

17. The device of claim 16, wherein a reflective material is applied to the first face and the second face.

18. The device of claim 16, wherein the substrate comprises a third face sloping from the first face side opposite of the second face toward the second face side.

19. The device of claim 13, further comprising a diffusion lens covering the first light source, and configured to diffuse the light emitted from the first light source.

20. The device of claim 13, further comprising a diffusion restraining member configured to restrain an amount of light, the light being emitted from the second light source and diffusing into the first area without passing through the light guide plates.
